(19) United States
(12) Patent Application Publication
(10) Pub. No.: US 2018/0158447 A1
(43) Pub. Date: Jun. 7, 2018

(54) ACOUSTIC ENVIRONMENT UNDERSTANDING IN MACHINE-HUMAN SPEECH COMMUNICATION

(71) Applicant: INTEL CORPORATION, Santa Clara, CA (US)

(72) Inventors: Przemyslaw Maziewski, Gdansk (PL); Pawel Trella, Gdansk (PL); Sylwia Buraczewska, Gdansk (PL)

(73) Assignee: INTEL CORPORATION, Santa Clara, CA (US)

(21) Appl. No.: 15/502,926

(22) PCT Filed: Apr. 1, 2016
(86) PCT No.: PCT/US2016/025680

§ 371 Date: Feb. 9, 2017

(51) Int. Cl. G10L 13/033; G10L 13/04

(52) U.S. Cl. CPC G10L 13/033; G10L 13/04

(57) ABSTRACT

An apparatus for acoustical environment understanding in machine-human speech communication is described herein. The apparatus includes one or more microphones to receive audio signals and a sound level metering unit. The sound level metering unit is to determine an environmental sound level based on the audio signals. The apparatus also includes an artificial speech generator that is to render artificial speech based on the environmental sound level.

### BACKGROUND ART

Electronic devices may be equipped with various applications that enable speech synthesis. For example, a text-to-speech (TTS) system may convert normal language text into speech. An automatic speech recognition (ASR) system may recognize human speech and reply with artificial speech synthesized or generated by the electronic device. Machine-to-human speech communication may be performed without accounting for the acoustical conditions in which the artificial speech is rendered.

### BRIEF DESCRIPTION OF THE DRAWINGS

FIG. 1 is a block diagram of an electronic device that enables acoustical environment understanding in machine-human speech communication;

FIG. 2 is an illustration of an audio processing pipeline;

FIG. 3 is a process flow diagram of a method for sound level metering;

FIG. 4 is a process flow diagram of a method that enables acoustical environment understanding in machine-human speech communication;

FIG. 5 is a process flow diagram of a method that enables acoustical environment understanding in machine-human speech communication; and

FIG. 6 is a block diagram showing a medium that enables acoustical environment understanding in machine-human speech communication.

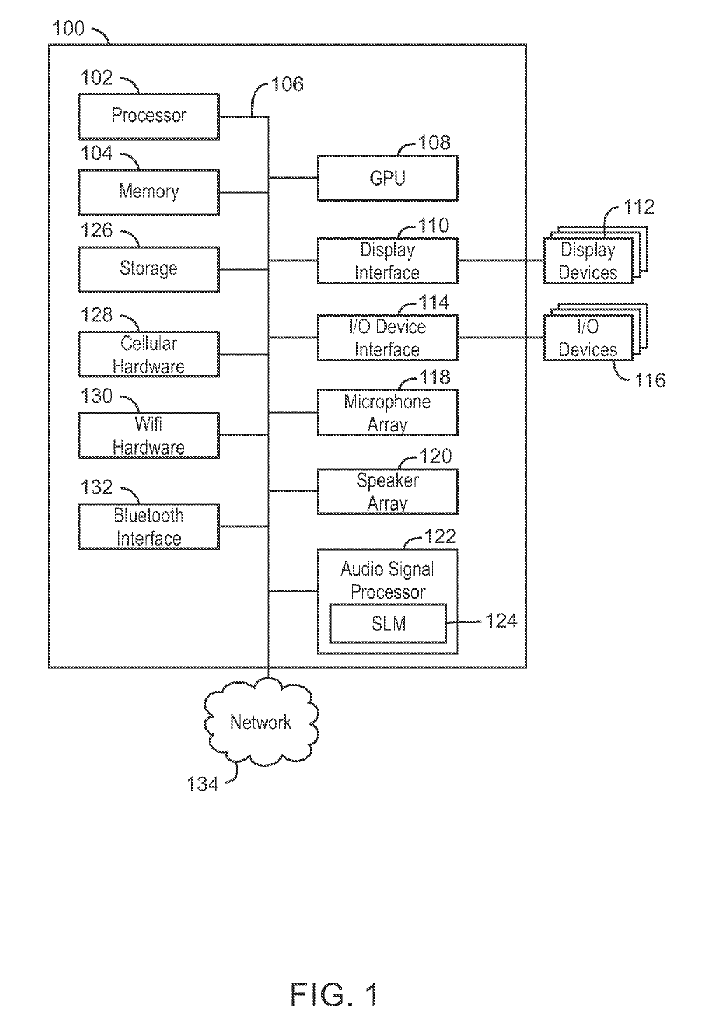

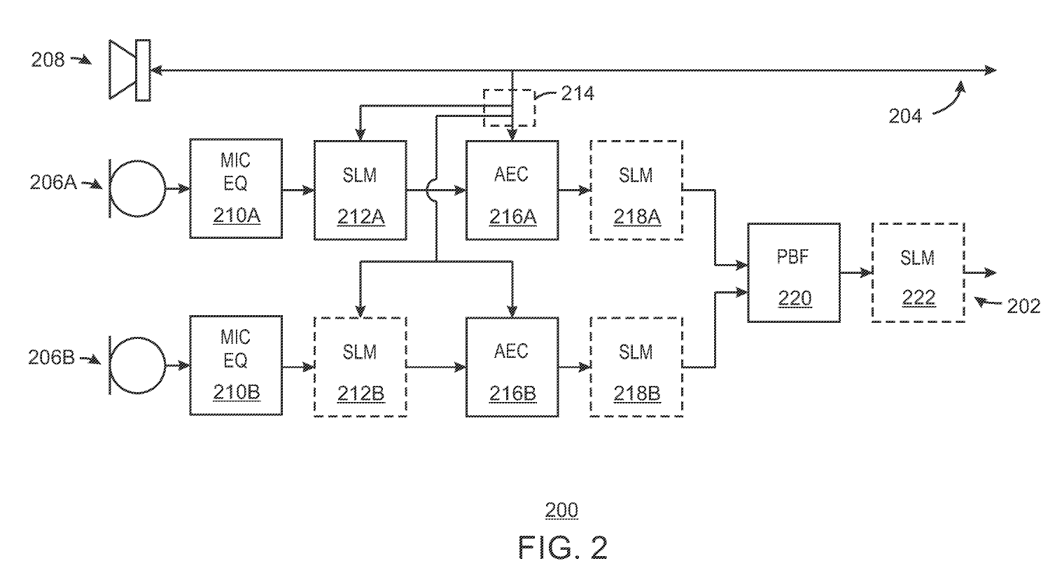

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In human-to-human communication, the audibility of human speech is enhanced by such phenomena as the Lombard Effect. The Lombard Effect describes the involuntary tendency of speakers to increase their vocal effort when speaking in loud environments. By contrast, the artificial speech generated by electronic devices typically does not include any modification based on the acoustic environment in which the speech occurs. Thus, artificial speech often does not compliment the environment I which it occurs.

Embodiments described herein enable acoustical environment understanding in machine-human speech communication. In embodiments, digital signal processing algorithms may be used for accurate sound level metering (SLM) in a microphone signal processing pipeline. The sound level metering may be performed via a pre-processing pipeline. Additionally, the values coming from the used SLM algorithms strongly correlate with loudness perceived by humans. This enables electronic devices to sense the loudness of the environment they operate in, which includes both the background noise and the user speech level. Electronic devices equipped with the Automatic Speech Recognition (ASR) and Text-To-Speech (TTS) functionalities can adjust their speech responses' levels accordingly, based on acoustic environment information. Additionally, the electronic devices can warn users in potentially harmful situations when exposed to a loud sound above a hearing damage threshold.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device that enables acoustical environment understanding in machine-human speech communication. The electronic device 100 may be, for example, a laptop computer, tablet computer, mobile phone, smart phone, or a wearable device, among others. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, or the like, to be displayed to a user of the electronic device 100. In some embodiments, the GPU 108 includes a number of graphics engines, wherein each graphics engine is configured to perform specific graphics tasks, or to execute specific types of workloads. For example, the GPU 108 may include an engine that processes video data.

The CPU 102 can be linked through the bus 106 to a display interface 110 configured to connect the electronic device 100 to a display device 112. The display device 112 can include a display screen that is a built-in component of the electronic device 100. The display device 112 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

The electronic device 100 also includes a microphone array 118 for capturing audio. The microphone array 118 can include any number of microphones, including one, two, three, four, five microphones or more. Similarly, a speaker array 120 can include a plurality of speakers. An audio signal processing mechanism 122 may be used to process audio signals captured or emitted by the electronic device 100. For example, audio captured by the microphone may be processed by the audio signal processing mechanism 122 for applications such as automatic speech recognition (ASR). The audio signal processing mechanism 122 may also process audio signals to be emitted from the speaker array 120, as in the case of machine-to-human speech.

A sound level metering (SLM) mechanism 124 is to sense the loudness of the environment in which the electronic device 100 is located. The loudness sensed may include both the background noise and a user speech level. The SLM mechanism 122 can dynamically adjust the artificial speech responses of the electronic device, such that the electronic device can respond in a manner that is appropriate for the noise levels of the surrounding environment. The SLM mechanism 122 can dynamically adjust the generated artificial speech by adjusting the volume, tone, frequency, and other characteristics of the artificial speech so that it complements the environmental conditions. The SLM mechanism 124 also senses the acoustics of the environment, and modifies the machine speech so that it is complimentary to the environment.

The electronic device may also include a storage device 126. The storage device 126 is a physical memory such as a hard drive, an optical drive, a flash drive, an array of drives, or any combinations thereof. The storage device 126 can store user data, such as audio files, video files, audio/video files, and picture files, among others. The storage device 126 can also store programming code such as device drivers, software applications, operating systems, and the like. The programming code stored to the storage device 126 may be executed by the CPU 102, GPU 108, or any other processors that may be included in the electronic device 100.

The CPU 102 may be linked through the bus 106 to cellular hardware 128. The cellular hardware 128 may be any cellular technology, for example, the 4G standard (International Mobile Telecommunications-Advanced (IMT-Advanced) Standard promulgated by the International Telecommunications Union-Radio communication Sector (ITU-R)). In this manner, the PC 100 may access any network 126 without being tethered or paired to another device, where the network 134 is a cellular network.

The CPU 102 may also be linked through the bus 106 to WiFi hardware 130. The WiFi hardware is hardware according to WiFi standards (standards promulgated as Institute of Electrical and Electronics Engineers' (IEEE) 802.11 standards). The WiFi hardware 130 enables the electronic device 100 to connect to the Internet using the Transmission Control Protocol and the Internet Protocol (TCP/IP), where the network 134 is the Internet. Accordingly, the electronic device 100 can enable end-to-end connectivity with the Internet by addressing, routing, transmitting, and receiving data according to the TCP/IP protocol without the use of another device. Additionally, a Bluetooth Interface 132 may be coupled to the CPU 102 through the bus 106. The Bluetooth Interface 132 is an interface according to Bluetooth networks (based on the Bluetooth standard promulgated by the Bluetooth Special Interest Group). The Bluetooth Interface 132 enables the electronic device 100 to be paired with other Bluetooth enabled devices through a personal area network (PAN). Accordingly, the network 134 may be a PAN. Examples of Bluetooth enabled devices include a laptop computer, desktop computer, ultrabook, tablet computer, mobile device, or server, among others.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

The present techniques take into account the acoustic environmental conditions in which the device operates. This results in all responses emitted by the device being generated at various sound levels, dependent upon the acoustic environment. In embodiments, the sound levels of the machine responses are also based on environmental noise and human interlocutor speech levels. Additionally, machine responses may be scaled by amplifying or decreasing the volume level of the response depending on the background noise and human speech levels. For example, the device can answer in loud speech when operating in a noisy office (during daytime) or quietly when being at home with a user whispering to it (night time). In embodiments, the device may also prevent users from hearing damage and/or warn against hearing damage. This can be done either by not exposing users to too loud sound generated by the device or by warning users when such acoustic conditions are detected. In embodiments, users may be issued a warning when the sound level is above a threshold.

FIG. 2 is an illustration of an audio processing pipeline 200. The audio processing pipeline 200 includes a capture audio stream 202 and a render audio stream 204. The audio may be captured by a microphone 206A and a microphone 206B. The audio may be rendered by a speaker 206. For ease of description, a single speaker and two microphones are illustrated. However, the present techniques may apply to any number of speaker and microphones. The microphones are calibrated to ensure accurate adjustment of the artificial speech. In embodiments, properly calibrated microphones enable accurate sound level measurements.

In embodiments, the audio processing pipeline 200 is an audio pre-processing pipeline. In examples, the audio processing pipeline 200 may perform microphone signal conditioning. As used herein, signal conditioning includes, but is not limited to, manipulating the captured audio so that it meets the requirements of a next stage of audio processing. In some cases, signal conditioning includes filtering and amplifying the captured audio signals.

At blocks 210A and 210B, microphone signal equalization (MIC EQ) is performed. Microphone signal equalization increases or decreases the signal strength of the captured audio for a band of audio frequencies. In this manner, the frequency components of the captured audio signal can be balanced for practical or aesthetic reasons. At blocks 212A and 212B, sound level metering (SLM) is performed. The SLM blocks 212A and 212B calculate sound levels of the captured audio. Once the sound level is determined, the SLM blocks 212A and 212B can provide feedback or a reference for decision making. For example, decision making includes determining if what the SLM is measuring at a particular moment is mostly acoustical echo (if render feedback is strong), useful speech, or environmental noise floor (if render feedback is low). Additionally, the SLM blocks 212A and 212B can provide feedback to the render stream 204 so that any rendered audio can be adjusted based on the sound levels captured by the microphones 206A and 206B. In embodiments, a loopback stream 214 may send the audio to be rendered to each SLM block 212A and 212B. In this manner, the SLM block can also use the sound levels of the audio to be rendered in calculating the appropriate sound levels of be applied to the render stream. The SLM blocks 212A and 212B may have additional logic enabling the recognition of situations when its readings are affected by self-generated sound (leakage). In embodiments, the loopback 214 enables the detection of this sound leakage.

In embodiments, the SLM is applied dynamically, in real-time. As used herein, real time refers to an automatic, instant sound level metering so that no delay is perceived by a user. When calculating sound levels of the captured audio, the SLM requires the flat frequency response (FR) of the measuring microphone. Thus, the microphone equalization blocks 210A and 210B may be used to correct any non-flatness of the frequency response of the captured audio. The pre-processing pipeline may include more than one SLM block.

The SLM calculations may be performed using time- and frequency-weighted SLM routines. In embodiments, the SLM calculations are according to the International Electrotechnical Commission (IEC) Specification 61672-1:2013, published on Sep. 30, 2013. The SLM block 212A and 212B may measure exponential-time-weighted, frequency-weighted sound levels, time-averaged, frequency-weighted sound levels, and frequency-weighted sound exposure levels. Weighting and filtering functions may be applied to the captured audio.

In order to approximate the loudness or sound level to be applied to the rendered machine response, the frequency of the captured audio may be weighted. The frequency weighting applied to the captured audio according to the present techniques is A-weighting as described by the IEC Specification 61672-1:2013. Similar to the human ear, A-weighting cuts off the lower and higher frequencies typically not perceived by humans resulting in a frequency response also referred to as an A-curve. Thus A-curve frequency weighting of the sound level is a good approximation of the loudness perceived by humans. The A-curve frequency weighting is a quick calculation that enables real-time computation. In embodiments, a loudness model is used to determine the loudness perceived by human ears instead of A-weighting as described above, such as a psycho-acoustic model for temporally variable sounds.

At blocks 216A and 216B, acoustic echo cancellation (AEC) is performed. Performing AEC removes any echoes from the audio data, ensuring a high quality signal. At blocks 218A and 218B, SLM may be utilized for pipeline tuning. In embodiments, pipeline turning is a manual or semiautomatic procedure performed in order to find the best set of parameters of each of the processing block in the pipeline. For example, the AEC at blocks 216A and 216B each have a set of parameters, such as a filter length. In such a case, pipeline tuning includes determining the proper filter length that works for that particular device.

In embodiments, the second set of SLM blocks 218A and 218B indicates how the consecutive processing blocks modify microphone signal. At block 220, phase based beamforming (PBF) is performed. Beamforming may be accomplished using differing algorithms and techniques. Each beamforming algorithm is to enable directional signal transmission or reception by combining elements in an array in a way where signals at particular angles experience constructive interference and while others experience destructive interference. At block 222, further pipeline tuning is performed via SLM. Here, pipeline tuning include reading the sound level to determine the effects of prior tuning. For example, when changes are made to some parameters of PBF 220, further tuning can show how these changes affect the sound level.

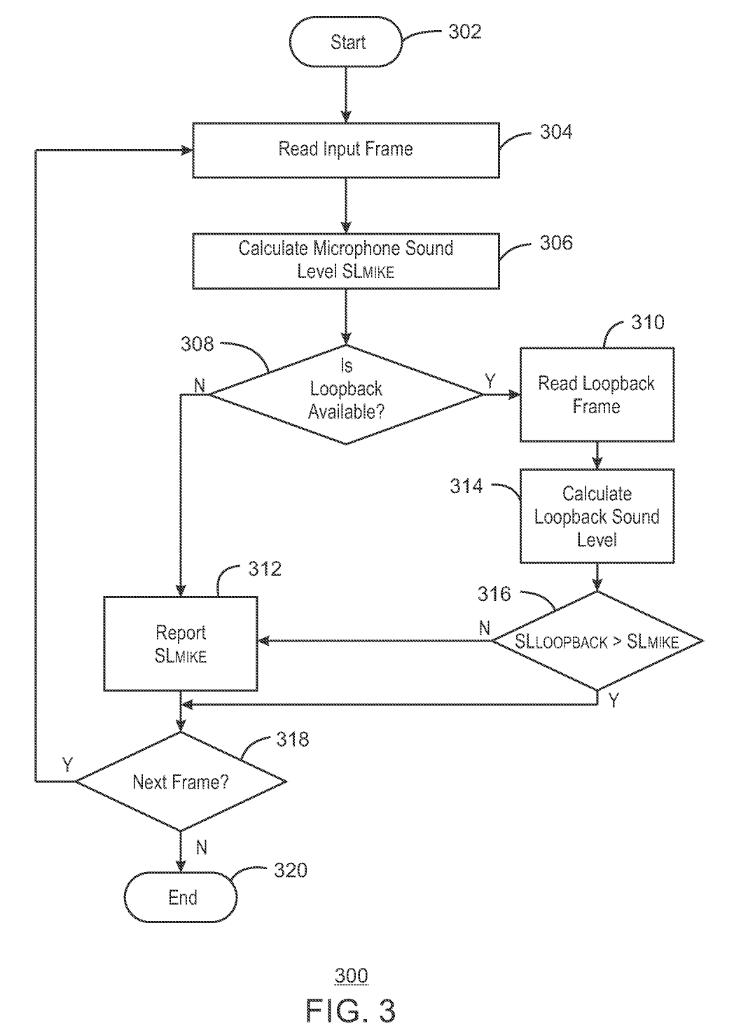

FIG. 3 is a process flow diagram of a method 300 for sound level metering. In FIG. 3, a particular strategy is applied for the SLM loopback processing. The SLM loopback processing can stop operating during periods when the self-sound is generated. Alternatively, assuming the SLM is calibrated to rescale digital loopback levels to the self-generated SLs, the measured SLs higher than the self-generated ones are reported. The SLM can be calibrated during the tuning phase to scale the loopback signal to physical SL readings.

At block 302, process flow begins. At block 304, an input frame is read. At block 306, the microphone sound level SL_{MIKE} is calculated. The microphone sound level is calculated according to IEC standards. At block 308, it is determined if the loopback mechanism is available. If the loopback mechanism is available, process flow continues to block 310. If the loopback mechanism is not available, process flow continues to block 312.

At block 310, the loopback frame is read. At block 314, the loopback sound level SL_{LOOPBACK} is determined. At block 316, it is determined if the loopback sound level SL_{LOOPBACK} is greater than the input sound level SL_{MIKE}. If the loopback sound level SL_{LOOPBACK} is greater than the input sound level SL_{MIKE}, process flow continues to block 318. If the loopback sound level SL_{LOOPBACK} is not greater than the input sound level SL_{MIKE}, process flow continues to block 312. At block 312, the input sound level SL_{MIKE} is reported as the acoustical sound level. At block 318, it is determined if there is a next frame available. If there is a next frame available, process flow returns to block 304 where the next input frame is read. If there is not a next frame available, process flow continues to block 320 where the process ends.

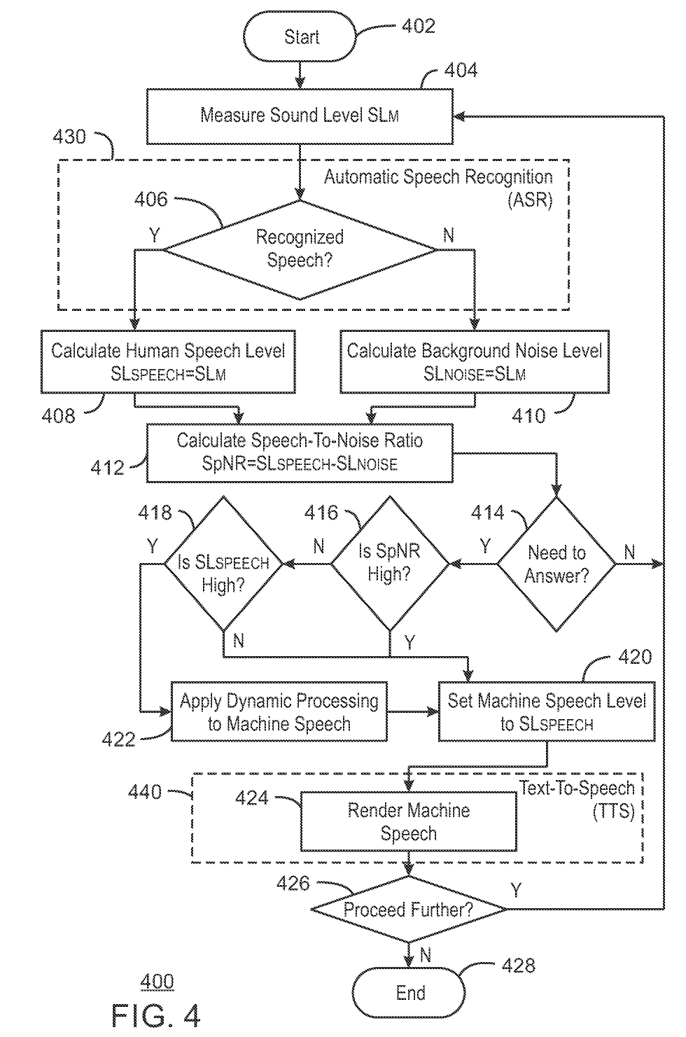

FIG. 4 is a process flow diagram of a method 400 that enables acoustical environment understanding in machine-human speech communication. The process begins at block 402. At block 404, the input sound level SL_{M} of captured audio is measured. At block 406, it is determined if the captured audio includes recognized speech. If the captured audio includes recognized speech, process flow continues to block 408. If the captured audio does not includes recognized speech, process flow continues to block 410. At block 408, the human speech sound level SL_{SPEECH} is set equal to the input sound level SL_{M}. At block 410, the background noise level SL_{NOISE} is set equal to the input sound level SL_{M}. While the flowchart illustrates discrete blocks for various tasks, the method described herein is a continuous process where one or more portions are performed simultaneously. In embodiments, the background noise level SL_{NOISE} may be determined in between the sentences (or can be done even in between the words) so it is being updated during other calculations.

At block 412, a speech to noise ratio SpNR is calculated as the difference between the human speech sound level SL_{SPEECH} minus the background noise level SL_{NOISE}. At block 414, it is determined if there is a need for an artificial response from the machine. If there is no need for a response, process flow returns to block 404. If there is a need for a response, process flow continues to block 416. At block 416, it is determined if the speech to noise ratio SpNR is high. Generally, a positive speech to noise ratio SpNR is high, while a negative speech to noise ratio SpNR is low. In embodiments, zero can be a default threshold applied to the speech to noise ratio SpNR. If the speech to noise ratio SpNR is not high, process flow continues to block 418. If the speech to noise ratio SpNR is high, process flow continues to block 420.

At block 418, it is determined if the human speech sound level SL_{SPEECH} is high. In embodiments, the human speech sound level SL_{SPEECH} is high when greater than a threshold, such as 65 dB. In embodiments, 65 dB is considered a normal, threshold sound level. Higher decibel sound levels can be considered as proportionally high. If the human speech sound level SL_{SPEECH} is not high, process flow continues to block 420. If the human speech sound level SL_{SPEECH} is high, process flow continues to block 422. At block 422, dynamic processing is added to machine speech. In embodiments, dynamic processing is a sound processing technique used to change dynamic range of the audio/speech signal, meaning that the initial amplitude range can be modified. For example, a speech signal with high and low amplitudes can be modified to speech signal with high amplitudes only. At block 420, the machine speech level is set to be equal to the human speech sound level SL_{SPEECH}.

At block 424, the machine speech is rendered at the human speech sound level SL_{SPEECH}. At block 426, it is determined if the communication is finished. If the communication is finished, process flow returns to block 404 where the sound level is measured. If the communication is not finished, process flow ends at block 428.

The SLM block, as illustrated by FIG. 4, measures SL in real-time and provides its readings to the application/service responsible for the machine-to-human communication. In embodiments, the SL can be exposed under a dedicated registry key or by another means in operating systems. Typically, the ASR application 430 is aware when speech utterances where recognized. Thus the SL readings from such time regions can be treated as the human speech levels SL_{SPEECH} and intermediate ones as the background noise levels SL_{NOISE}. Based on this information the application can adjust the loudspeaker levels (or equivalently the artificial speech level) that it will use for the machine-to-human communication.

Notice that in the situation when the SpNR is low and SL_{SPEECH} is high-which may indicate noisy environment with loud speech—additional processing can be applied to machine speech responses. This additional processing occurs at block 422, where dynamic processing, filtering or other techniques may be used to increase loudness and intelligibility. Those processing algorithms as well as the speech response level scanning can be implemented in the post-processing or render pipeline. Another use-case which can be supported with the SLM enriched pre-processing pipeline is a hearing damage monitor. The device equipped with the SLM can warn users against hearing damages when exposed to loud conditions (either external or self-generated). Additionally, a device with a calibrated SLM can be used as a reference to calibrate other devices.

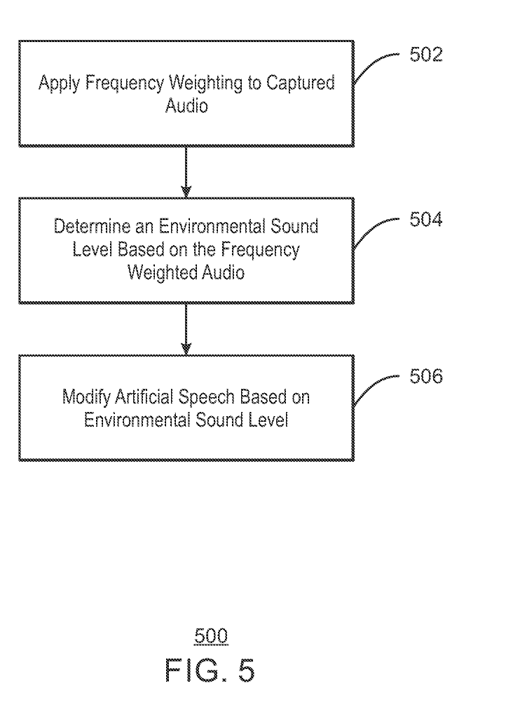

FIG. 5 is a process flow diagram of a method 500 that enables acoustical environment understanding in machine-human speech communication. At block 502, a frequency weighting is applied to the captured audio. In embodiments, the weighting is an A-weight as described by the IEC Specification 61672-1:2013. The weighting is described as A-weighting for exemplary purposes. However, other weighting is possible. For example, a C-curve or C-weighting as described by the IEC Specification 61672-1:2013 may be applied to the captured audio. Moreover, in embodiments, time weighting and root mean square (RMS) weighting may also be used.

At block 504, an environmental sound level is determined based on the frequency weighted audio. In embodiments, the sound level can include the sound level of human speech as well as background noise. At block 506, in response to a command to render speech, the sound level at which speech is to be rendered is modified to be complimentary to the environmental sound level. In embodiments, the sound level at which speech is to be rendered may be set as equal to the environmental sound level. In this manner, the artificial speech can be modified such that it is appropriate for the environmental conditions. Additionally, in embodiments, the present techniques may warn users when sound is too loud. Moreover, a user may be prompted to input how much time is needed to recover from a loud sound, and not listen to loud sounds during that time period. The artificial speech may be rendered at a low level based the period of time obtained from a user based on the prompt. In embodiments, the low level may be low relative to the environmental sound level.

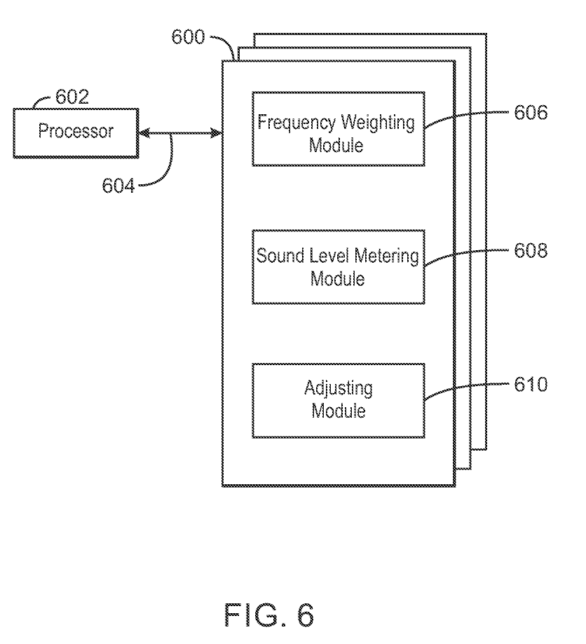

FIG. 6 is a block diagram showing a medium 600 that enables acoustical environment understanding in machine-human speech communication. The medium 600 may be a computer-readable medium, including a non-transitory medium that stores code that can be accessed by a processor 602 over a computer bus 604. For example, the computer-readable medium 600 can be volatile or non-volatile data storage device. The medium 600 can also be a logic unit, such as an Application Specific Integrated Circuit (ASIC), a Field Programmable Gate Array (FPGA), or an arrangement of logic gates implemented in one or more integrated circuits, for example.

The medium 600 may include modules 606-610 configured to perform the techniques described herein. For example, a frequency weighting module 606 may be configured to filter captured audio so that is more closely resembles what humans hear. A sound level module 608 may be configured to determine the environmental sound level. An adjusting module 610 may be configured to adjust the sound level of speech to be rendered. In some embodiments, the modules 606-610 may be modules of computer code configured to direct the operations of the processor 602.

The block diagram of FIG. 6 is not intended to indicate that the medium 600 is to include all of the components shown in FIG. 6. Further, the medium 600 may include any number of additional components not shown in FIG. 6, depending on the details of the specific implementation.

Example 1 is an apparatus for acoustical environment understanding in machine-human speech communication. The apparatus includes one or more microphones to receive audio signals; a sound level metering unit to determine an environmental sound based, at least partially, on the audio signals and frequency weighting; and an artificial speech generator to render artificial speech based on the environmental sound level.

Example 2 includes the apparatus of example 1, including or excluding optional features. In this example, determining an environmental sound level comprises applying A-weighting to the audio signals.

Example 3 includes the apparatus of any one of examples 1 to 2, including or excluding optional features. In this example, the sound level metering unit is to measure time-weighted sound levels and frequency-weighted sound levels of the environment based on the audio signals.

Example 4 includes the apparatus of any one of examples 1 to 3, including or excluding optional features. In this example, the sound level metering unit is to dynamically adjust the modified artificial speech.

Example 5 includes the apparatus of any one of examples 1 to 4, including or excluding optional features. In this example, the apparatus includes a loopback mechanism that provides feedback from the rendered artificial speech and other self-generated sounds to the sound level metering unit.

Example 6 includes the apparatus of any one of examples 1 to 5, including or excluding optional features. In this example, the artificial speech is rendered at a volume level based on the environmental sound level.

Example 7 includes the apparatus of any one of examples 1 to 6, including or excluding optional features. In this example, the artificial speech is rendered at a low level for a period of time based on a prompt that is provided to a user.

Example 8 includes the apparatus of any one of examples 1 to 7, including or excluding optional features. In this example, an alert is issued in response to the environmental sound level being above a threshold.

Example 9 includes the apparatus of any one of examples 1 to 8, including or excluding optional features. In this example, the sound level metering unit is to detect the portion of the environmental sound level that is due to leakage.

Example 10 includes the apparatus of any one of examples 1 to 9, including or excluding optional features. In this example, sound level metering is applied dynamically.

Example 11 includes the apparatus of any one of examples 1 to 10, including or excluding optional features. In this example, the one or more microphones are calibrated to enable accurate sound level metering.

Example 12 is a method for acoustical environment understanding in machine-human speech communication. The method includes applying frequency weighting to audio captured by a microphone; determining an environmental sound level based on the weighted audio; and modifying an artificial speech to be rendered to make the artificial speech complementary to the environmental sound level.

Example 13 includes the method of example 12, including or excluding optional features. In this example, the frequency weighting is an A-weighting.

Example 14 includes the method of any one of examples 12 to 13, including or excluding optional features. In this example, the frequency weighting is a C-weighting, time weighting, root mean square weighting, or any combination thereof.

Example 15 includes the method of any one of examples 12 to 14, including or excluding optional features. In this example, the environmental sound level is determined via a sound level metering unit that is to measure time-weighted sound levels and frequency-weighted sound levels of the environment based on the audio signals.

Example 16 includes the method of any one of examples 12 to 15, including or excluding optional features. In this example, the artificial speech level is set as equal to a human speech level in response to a speech to noise ratio being high.

Example 17 includes the method of any one of examples 12 to 16, including or excluding optional features. In this example, dynamic processing is added to the artificial speech in response to a human speech level being high and a speech to noise ratio being low.

Example 18 includes the method of any one of examples 12 to 17, including or excluding optional features. In this example, artificial speech is rendered at a volume level based on the environmental sound level.

Example 19 includes the method of any one of examples 12 to 18, including or excluding optional features. In this example, an alert is issued in response to the environmental sound level being above a threshold.

Example 20 includes the method of any one of examples 12 to 19, including or excluding optional features. In this example, the sound level metering unit is to detect the portion of the environmental sound level that is due to leakage.

Example 21 includes the method of any one of examples 12 to 20, including or excluding optional features. In this example, the method includes a loopback mechanism that provides feedback from the rendered artificial speech to the sound level metering unit.

Example 22 includes the method of any one of examples 12 to 21, including or excluding optional features. In this example, the microphone is calibrated to enable accurate sound level metering.

Example 23 is a system for acoustical environment understanding in machine-human speech communication. The system includes one or more microphones to receive audio signals; a memory configured to receive data; and a processor coupled to the memory, the processor to: apply frequency weighting to audio signals captured by a microphone; determine an environmental sound level based on the weighted audio signals; and modify an artificial speech to be rendered to make the artificial speech complementary to the environmental sound level.

Example 24 includes the system of example 23, including or excluding optional features. In this example, determining an environmental sound level comprises applying A-weighting to the audio signals.

Example 25 includes the system of any one of examples 23 to 24, including or excluding optional features. In this example, the sound level metering unit is to measure time-weighted sound levels and frequency-weighted sound levels of the environment based on the audio signals.

Example 26 includes the system of any one of examples 23 to 25, including or excluding optional features. In this example, the sound level metering unit is to dynamically adjust the modified artificial speech.

Example 27 includes the system of any one of examples 23 to 26, including or excluding optional features. In this example, the system includes a loopback mechanism that provides feedback from the rendered artificial speech and other self-generated sounds to the sound level metering unit.

Example 28 includes the system of any one of examples 23 to 27, including or excluding optional features. In this example, the artificial speech is rendered at a volume level based on the environmental sound level.

Example 29 includes the system of any one of examples 23 to 28, including or excluding optional features. In this example, the artificial speech is rendered at a low level for a period of time based on a prompt that is provided to a user.

Example 30 includes the system of any one of examples 23 to 29, including or excluding optional features. In this example, an alert is issued in response to the environmental sound level being above a threshold.

Example 31 includes the system of any one of examples 23 to 30, including or excluding optional features. In this example, the sound level metering unit is to detect the portion of the environmental sound level that is due to leakage.

Example 32 includes the system of any one of examples 23 to 31, including or excluding optional features. In this example, sound level metering is applied dynamically.

Example 33 includes the system of any one of examples 23 to 32, including or excluding optional features. In this example, the one or more microphones are calibrated to enable accurate sound level metering.

Example 34 is an apparatus for acoustical environment understanding in machine-human speech communication. The apparatus includes one or more microphones to receive audio signals; a sound level metering unit to determine an environmental sound level based, at least partially, on the audio signals and frequency weighting; and a means to render artificial speech based on the environmental sound level.

Example 35 includes the apparatus of example 34, including or excluding optional features. In this example, determining an environmental sound level comprises applying A-weighting to the audio signals.

Example 36 includes the apparatus of any one of examples 34 to 35, including or excluding optional features. In this example, the sound level metering unit is to measure time-weighted sound levels and frequency-weighted sound levels of the environment based on the audio signals.

Example 37 includes the apparatus of any one of examples 34 to 36, including or excluding optional features. In this example, the sound level metering unit is to dynamically adjust the generated artificial speech.

Example 38 includes the apparatus of any one of examples 34 to 37, including or excluding optional features. In this example, the apparatus includes a loopback mechanism that provides feedback from the rendered artificial speech and other self-generated sounds to the sound level metering unit.

Example 39 includes the apparatus of any one of examples 34 to 38, including or excluding optional features. In this example, the artificial speech is rendered at a volume level based on the environmental sound level.

Example 40 includes the apparatus of any one of examples 34 to 39, including or excluding optional features. In this example, the artificial speech is rendered at a low level for a period of time based on a prompt that is provided to a user.

Example 41 includes the apparatus of any one of examples 34 to 40, including or excluding optional features. In this example, an alert is issued in response to the environmental sound level being above a threshold.

Example 42 includes the apparatus of any one of examples 34 to 41, including or excluding optional features. In this example, the sound level metering unit is to detect the portion of the environmental sound level that is due to leakage.

Example 43 includes the apparatus of any one of examples 34 to 42, including or excluding optional features. In this example, sound level metering is applied dynamically.

Example 44 includes the apparatus of any one of examples 34 to 43, including or excluding optional features. In this example, the one or more microphones are calibrated to enable accurate sound level metering.

Example 45 is a tangible, non-transitory, computer-readable medium. The computer-readable medium includes instructions that direct the processor to applying frequency weighting to audio captured by a microphone; determining an environmental sound level based on the weighted audio; and modifying an artificial speech to be rendered to make the artificial speech complementary to the environmental sound level.

Example 46 includes the computer-readable medium of example 45, including or excluding optional features. In this example, the frequency weighting is an A-weighting.

Example 47 includes the computer-readable medium of any one of examples 45 to 46, including or excluding optional features. In this example, the frequency weighting is a C-weighting, time weighting, root mean square weighting, or any combination thereof.

Example 48 includes the computer-readable medium of any one of examples 45 to 47, including or excluding optional features. In this example, the environmental sound level is determined via a sound level metering unit that is to measure time-weighted sound levels and frequency-weighted sound levels of the environment based on the audio signals.

Example 49 includes the computer-readable medium of any one of examples 45 to 48, including or excluding optional features. In this example, the artificial speech level is set as equal to a human speech level in response to a speech to noise ratio being high.

Example 50 includes the computer-readable medium of any one of examples 45 to 49, including or excluding optional features. In this example, dynamic processing is added to the artificial speech in response to a human speech level being high and a speech to noise ratio being low.

Example 51 includes the computer-readable medium of any one of examples 45 to 50, including or excluding optional features. In this example, artificial speech is rendered at a volume level based on the environmental sound level.

Example 52 includes the computer-readable medium of any one of examples 45 to 51, including or excluding optional features. In this example, an alert is issued in response to the environmental sound level being above a threshold.

Example 53 includes the computer-readable medium of any one of examples 45 to 52, including or excluding optional features. In this example, the sound level metering unit is to detect the portion of the environmental sound level that is due to leakage.

Example 54 includes the computer-readable medium of any one of examples 45 to 53, including or excluding optional features. In this example, the computer-readable medium includes a loopback mechanism that provides feedback from the rendered artificial speech to the sound level metering unit.

Example 55 includes the computer-readable medium of any one of examples 45 to 54, including or excluding optional features. In this example, the microphone is calibrated to enable accurate sound level metering.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. An apparatus for acoustical environment understanding in machine-human speech communication, comprising:
one or more microphones to receive audio signals;
a sound level metering unit to determine an environmental sound based, at least partially, on the audio signals and frequency weighting; and
an artificial speech generator to render artificial speech based on the environmental sound level.

27. The apparatus of claim 26, wherein determining an environmental sound level comprises applying A-weighting to the audio signals.

28. The apparatus of claim 26, wherein the sound level metering unit is to measure time-weighted sound levels and frequency-weighted sound levels of the environment based on the audio signals.

29. The apparatus of claim 26, wherein the sound level metering unit is to dynamically adjust the modified artificial speech.

30. The apparatus of claim 26, comprising a loopback mechanism that provides feedback from the rendered artificial speech and other self-generated sounds to the sound level metering unit.

31. The apparatus of claim 26, wherein the artificial speech is rendered at a volume level based on the environmental sound level.

32. The apparatus of claim 26, wherein the artificial speech is rendered at a low level for a period of time based on a prompt that is provided to a user.

33. The apparatus of claim 26, wherein an alert is issued in response to the environmental sound level being above a threshold.

34. The apparatus of claim 26, wherein the sound level metering unit is to detect the portion of the environmental sound level that is due to leakage.

35. The apparatus of claim 26, wherein sound level metering is applied dynamically.

36. The apparatus of claim 26, wherein the one or more microphones are calibrated to enable accurate sound level metering.

37. A method for acoustical environment understanding in machine-human speech communication, comprising:
applying frequency weighting to audio captured by a microphone;
determining an environmental sound level based on the weighted audio; and
modifying an artificial speech to be rendered to make the artificial speech complementary to the environmental sound level.

38. The method of claim 37, wherein the frequency weighting is an A-weighting.

39. The method of claim 37, wherein the frequency weighting is a C-weighting, time weighting, root mean square weighting, or any combination thereof.

40. The method of claim 37, wherein the environmental sound level is determined via a sound level metering unit that is to measure time-weighted sound levels and frequency-weighted sound levels of the environment based on the audio signals.

41. The method of claim 37, wherein the artificial speech level is set as equal to a human speech level in response to a speech to noise ratio being high.

42. A system for acoustical environment understanding in machine-human speech communication, comprising:
one or more microphones to receive audio signals;
a memory configured to receive data; and
a processor coupled to the memory, the processor to:
apply frequency weighting to audio signals captured by a microphone;
determine an environmental sound level based on the weighted audio signals; and
modify an artificial speech to be rendered to make the artificial speech complementary to the environmental sound level.

43. The system of claim 42, wherein determining an environmental sound level comprises applying A-weighting to the audio signals.

44. The system of claim 42, wherein the sound level metering unit is to measure time-weighted sound levels and frequency-weighted sound levels of the environment based on the audio signals.

45. The system of claim 42, wherein the sound level metering unit is to dynamically adjust the modified artificial speech.

46. The system of claim 42, comprising a loopback mechanism that provides feedback from the rendered artificial speech and other self-generated sounds to the sound level metering unit.

47. At least one tangible, non-transitory, computer-readable medium comprising instructions that, when executed by a processor, direct the processor to:
applying frequency weighting to audio captured by a microphone;
determining an environmental sound level based on the weighted audio; and
modifying an artificial speech to be rendered to make the artificial speech complementary to the environmental sound level.

48. The at least one tangible, non-transitory, computer-readable medium of claim 47, wherein the artificial speech level is set as equal to a human speech level in response to a speech to noise ratio being high.

49. The at least one tangible, non-transitory, computer-readable medium of claim 47, wherein dynamic processing is added to the artificial speech in response to a human speech level being high and a speech to noise ratio being low.

50. The at least one tangible, non-transitory, computer-readable medium of claim 47, wherein artificial speech is rendered at a volume level based on the environmental sound level.
